(19) United States
(12) Patent Application Publication
(10) Pub. No.: US 2026/0321293 A1
(43) Pub. Date: Oct. 15, 2026

(54) SYSTEMS AND METHODS FOR SEARCHING VIDEO CONTENT USING CONTEXTUAL INPUT

(71) Applicant: Verizon Patent and Licensing Inc., Basking Ridge, NJ (US)

(72) Inventors: Ravi Kiran TUMMALA, Hyderabad (IN); Naga Venkata Raja Rajeswari TEDLA, Bangalore (IN); Gaurav BC, Hyderabad (IN); Vishal AGARWAL, Hyderabad (IN)

(73) Assignee: Verizon Patent and Licensing Inc., Basking Ridge, NJ (US)

(21) Appl. No.: 19/543,194

(22) Filed: Feb. 18, 2026

Related U.S. Application Data
(63) Continuation-in-part of application No. 19/179,333, filed on Apr. 15, 2025.

(51) Int. Cl. G11B 27/34; G06F 16/73; G06F 40/20; G06F 40/40; G06V 20/40

(52) U.S. Cl. CPC G11B 27/34; G06F 16/73; G06F 40/20; G06F 40/40; G06V 20/47

(57) ABSTRACT

A device may receive a user input describing a specific scene, and may derive context from and summarize the user input to generate a summarized contextual input. The device may assign an input vector to the summarized contextualized input using a paragraph vector model, may sample video samples of a video file to be searched, and may summarize context of the video samples into first sentences. The device may summarize transcripts of the video samples into second sentences, may apply weights to the first sentences and the second sentences to generate weighted sentences, and may translate the weighted sentences into sentence vectors using the paragraph vector model. The device may compare the input vector and the sentence vectors to identify the sentence vectors that are closest to the input vector, and may output timestamps in the video samples associated with the identified sentence vectors.

### CROSS-REFERENCE TO RELATED APPLICATION

This Patent Application is a Continuation-In-Part Patent Application and claims priority to U.S. Patent Application No. 19/179,333, filed on Apr. 15, 2025, and entitled “SYSTEMS AND METHODS FOR ENHANCING MEDIA FILE SEARCHABILITY.” The disclosure of the prior Application is considered part of and is incorporated by reference into this Patent Application.

### BACKGROUND

Digital video content is widely used in various applications. Tools and methods exist for interacting with and examining video files. Similarly, language models have expanded in use and have been applied to many existing technology areas to elevate user experience.

### BRIEF DESCRIPTION OF THE DRAWINGS

FIGS. 1A-1J are diagrams of an example associated with searching video content using contextual input.

FIG. 2 is a diagram of an example environment in which systems and/or methods described herein may be implemented.

FIG. 3 is a diagram of example components of one or more devices of FIG. 2.

FIG. 4 is a flowchart of example process for searching video content using contextual input.

### DETAILED DESCRIPTION OF EXAMPLE EMBODIMENTS

The following detailed description of example implementations refers to the accompanying drawings. The same reference numbers in different drawings may identify the same or similar elements.

In today's digital landscape, the proliferation of multimedia content (e.g., particularly video) has made video files a crucial medium for communication, customer interaction, and information sharing across industries. As organizations increasingly rely on recorded video for purposes such as customer support, training, analysis, and compliance, the ability to efficiently search, identify, and analyze specific scenes within lengthy video files has become highly desirable. However, traditional video search systems are often limited to basic metadata or transcript-based keyword searching, which fails to capture the nuanced context or meaning within individual scenes. As a result, users are typically required to manually review entire videos to locate relevant segments, leading to significant inefficiencies.

This manual review process can be time-consuming and resource-intensive, especially when dealing with long video recordings or large volumes of content. The inability of existing systems to semantically understand and search for specific actions, events, or contextual information within a video scene results in prolonged resolution times, increased operational costs, and reduced productivity. Furthermore, the lack of advanced scene-level search capabilities can hinder timely identification of critical moments, such as customer pain points, error occurrences, or compliance issues, which are essential for effective analysis and decision-making.

Thus, current techniques for searching video files may consume computing resources (e.g., processing resources, memory resources, communication resources, and/or the like), networking resources, and/or other resources associated with being limited to basic metadata or transcript-based keyword searching of video files, failing to capture nuanced context or meaning within individual scenes of video files, requiring manual review of entire videos to locate relevant segments based on failing to capture context or meaning within scenes of video files, and/or the like.

Some implementations described herein provide a device (e.g., a computer system and/or a user device) that searches video content using contextual input. For example, the device may receive a user input describing a specific scene, and may derive and summarize context from the user input to generate a summarized contextual input using a first model. The device may assign an input vector to the summarized contextualized input using a paragraph vector model, and may sample video samples of a video file to be searched. The device may extract and summarize context of the video samples into first sentences using a second model, and may analyze and summarize transcripts of the video samples into second sentences using the first model. The device may apply weights based on temporal relevance to the first sentences and the second sentences to generate weighted sentences, and may translate the weighted sentences into sentence vectors using the paragraph vector model. The device may compare the input vector and the sentence vectors to identify one or more of the sentence vectors that are closest to the input vector, and may output timestamps in the video samples associated with the one or more of the sentence vectors to enable searching of the video file.

In this way, the device searches video content using contextual input. For example, the device may overcome the inefficiencies of manual review and basic transcript-based search by utilizing contextual understanding and semantic comparison at a scene level. The device may reduce computational overhead by narrowing the search space to only segments that are contextually and semantically relevant. Additionally, by encoding and indexing video samples as vectors, the device may enable efficient retrieval and comparison operations, which may reduce latency and network resource consumption. The device may provide scalable video analytics and may integrate with automated downstream analysis pipelines, such as compliance monitoring or sentiment detection, without incurring the resource penalties associated with exhaustive or less targeted search methods. Thus, the device may conserve computing resources, networking resources, and/or other resources that would have otherwise been consumed by being limited to basic metadata or transcript-based keyword searching of video files, failing to capture nuanced context or meaning within individual scenes of video files, requiring manual review of entire videos to locate relevant segments based on failing to capture context or meaning within scenes of video files, and/or the like, and/or the like.

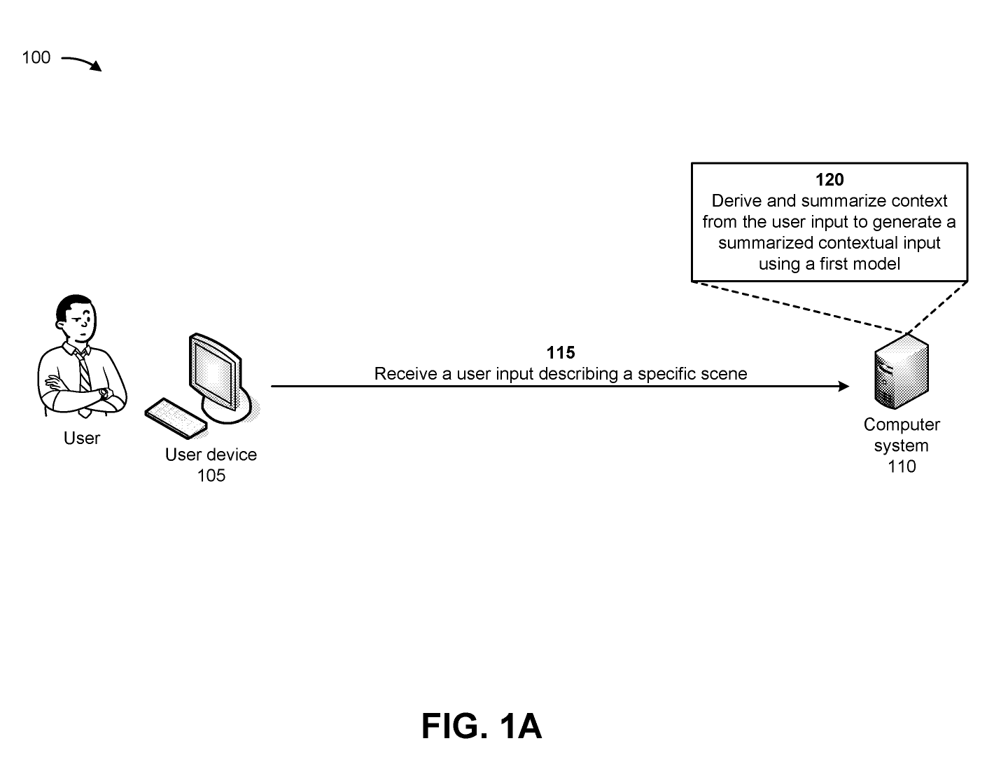

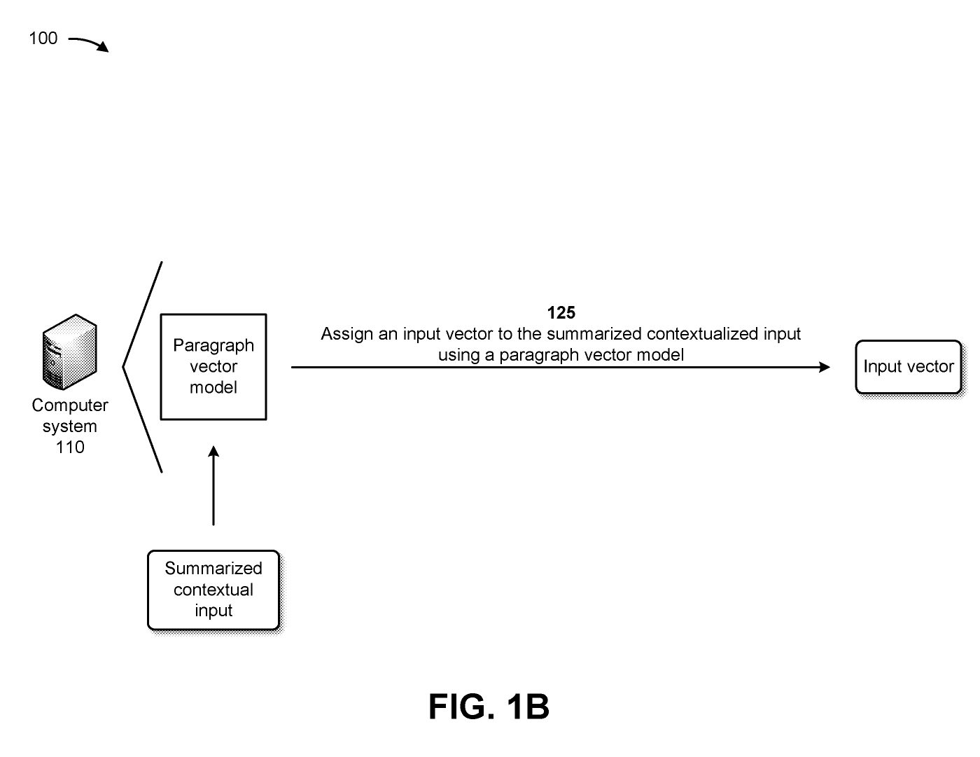

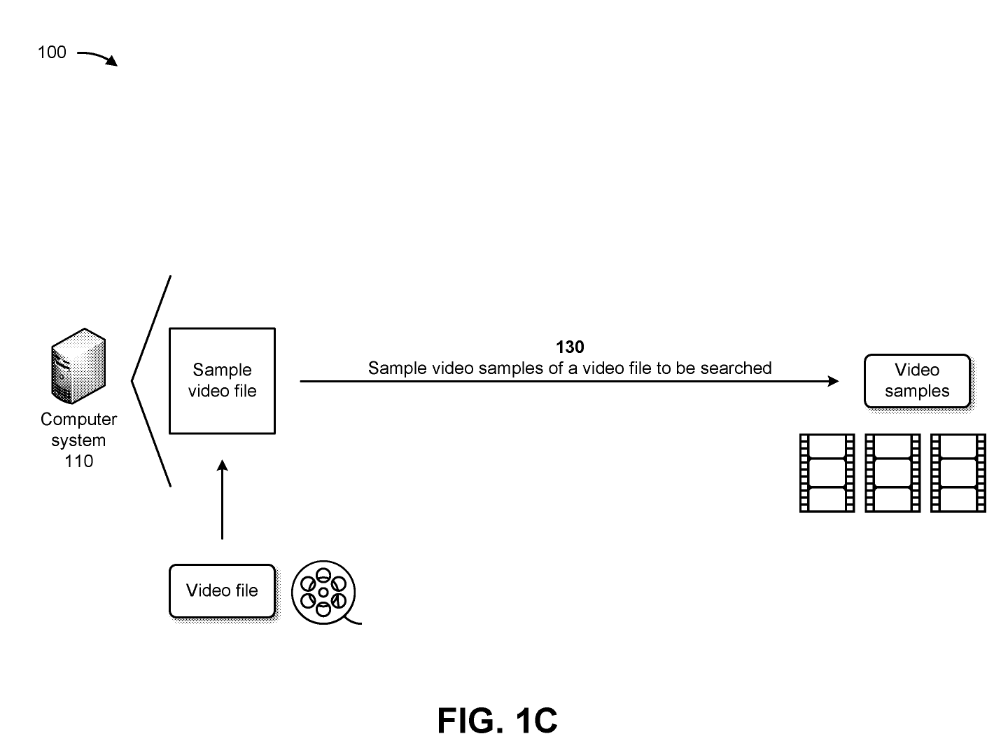

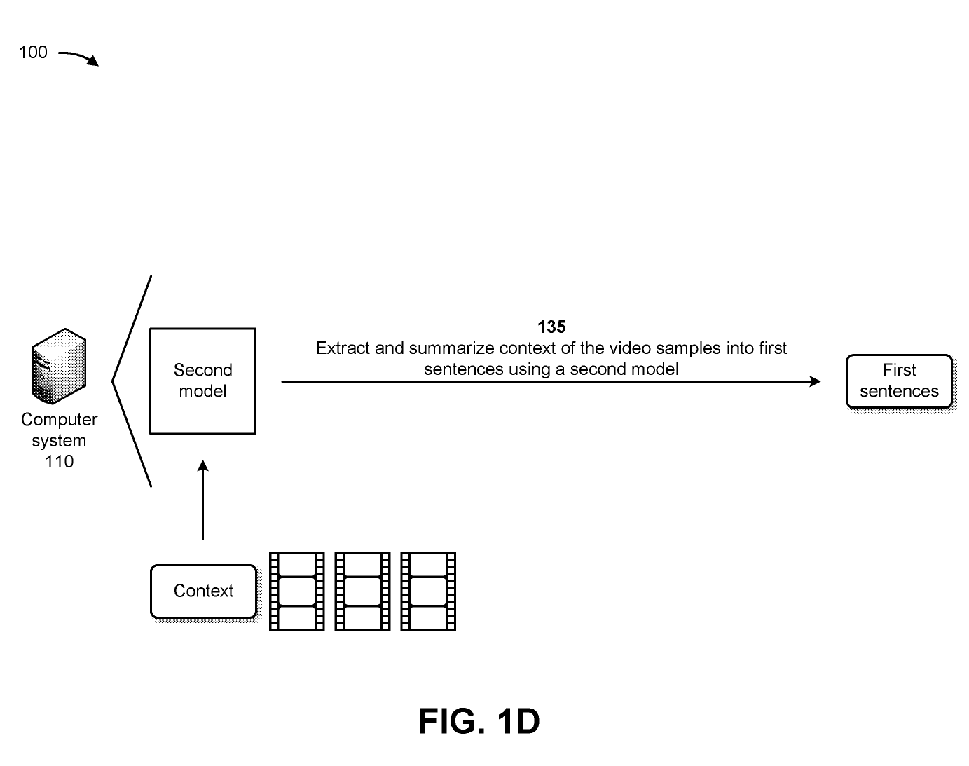

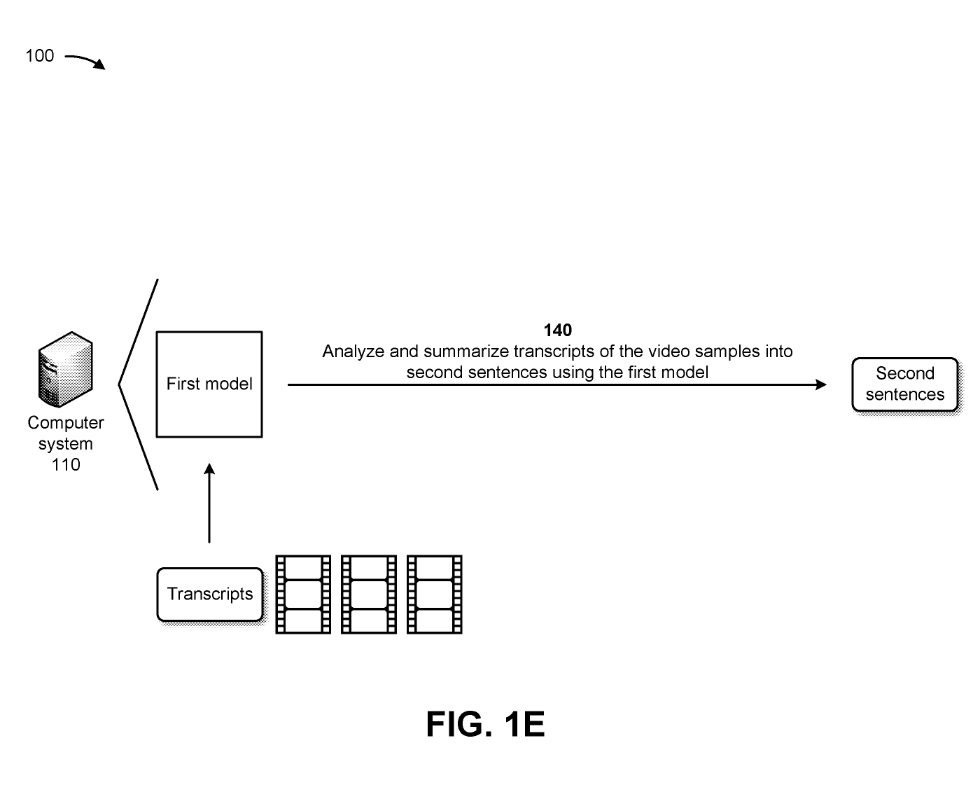

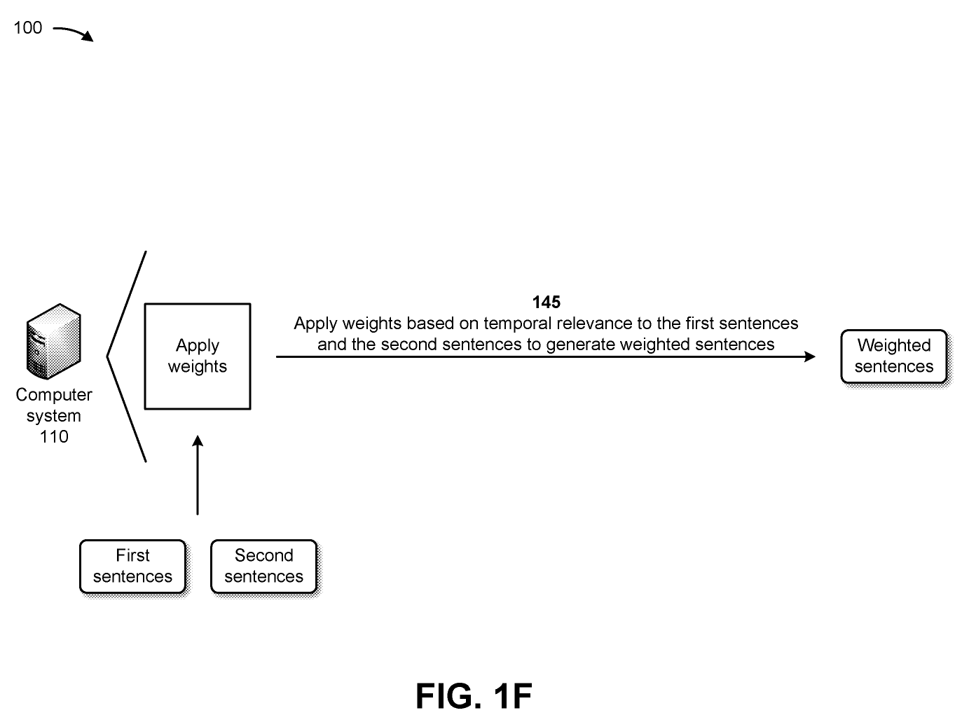

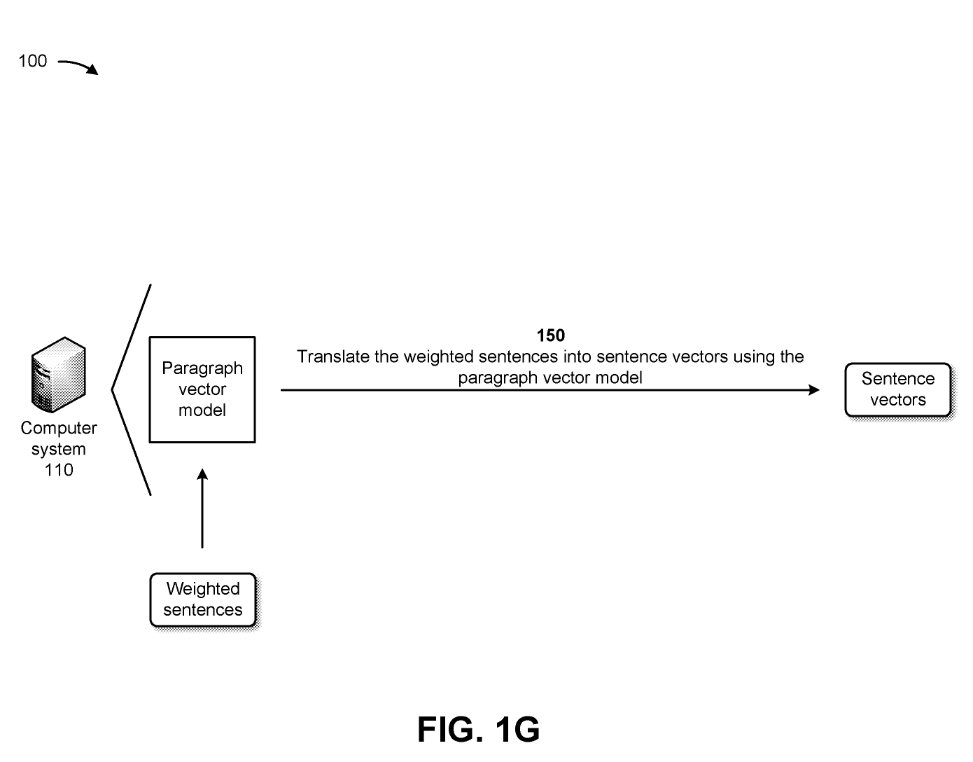

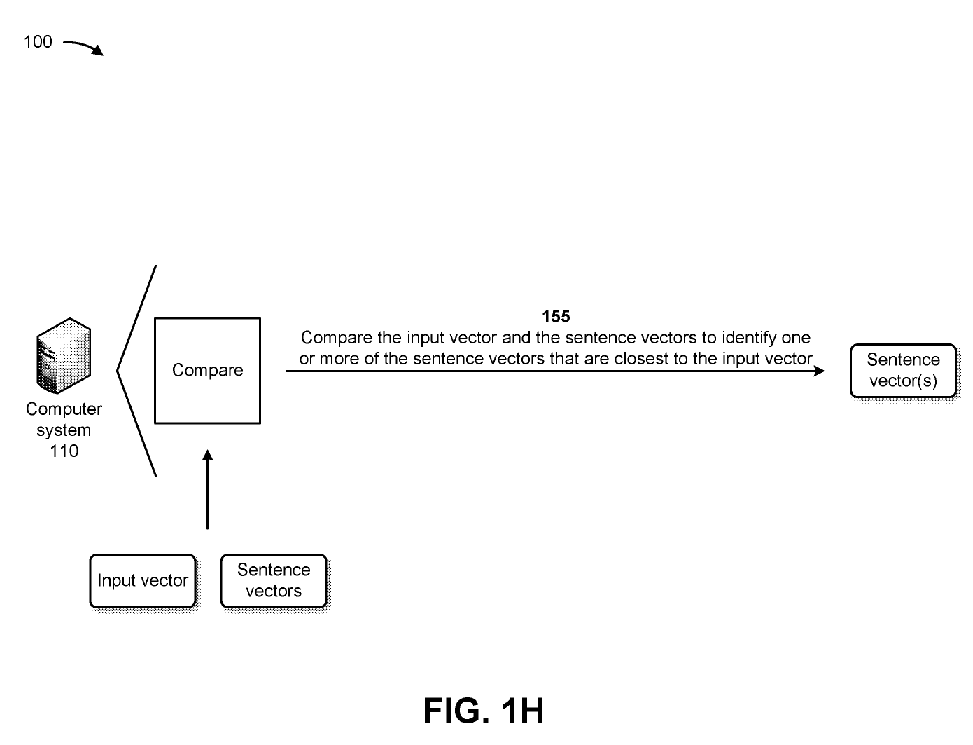

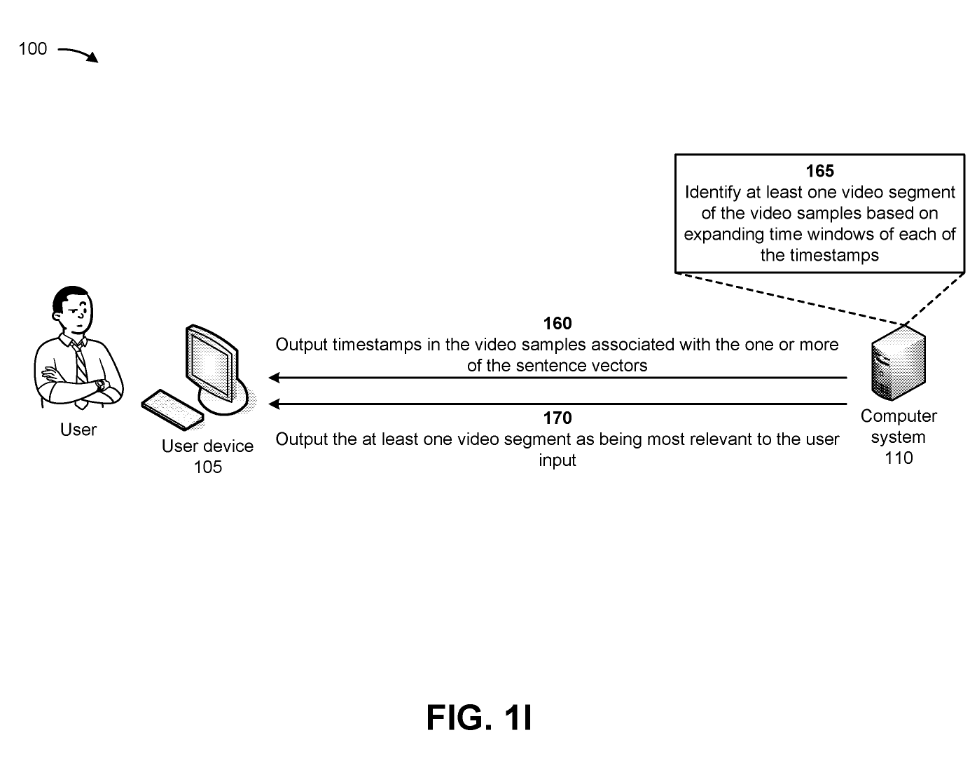

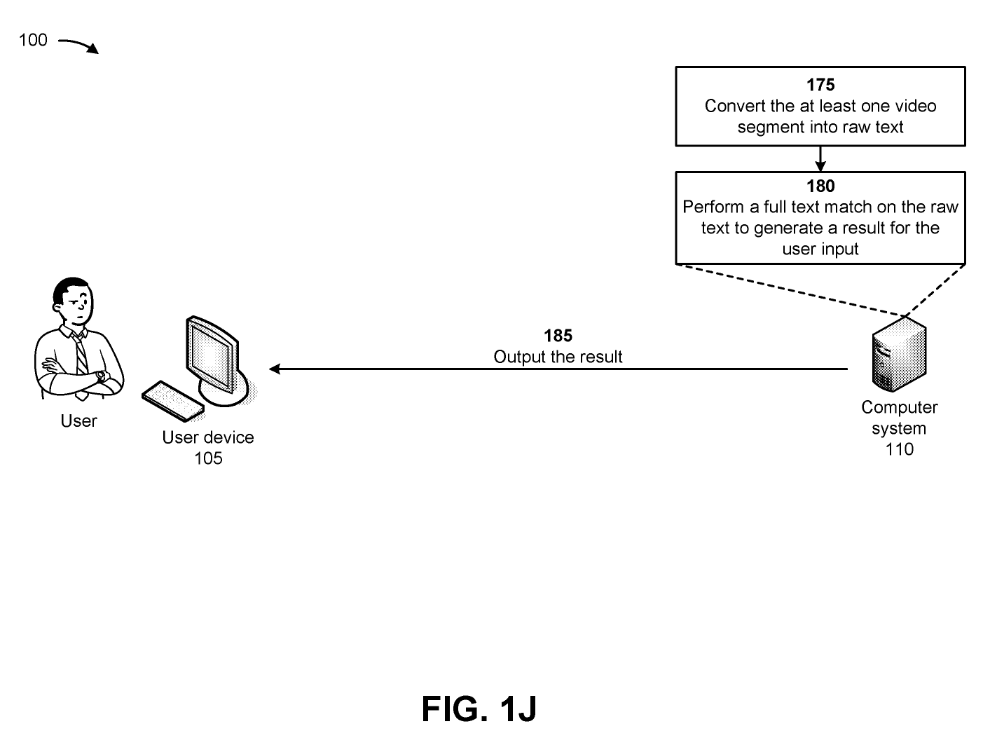

FIGS. 1A-1J are diagrams of an example 100 associated with searching video content using contextual input. As shown in FIGS. 1A-1J, the example 100 includes a user device 105 (e.g., associated with a user) and a computer system 110. Further details of the user device 105 and the computer system 110 are provided elsewhere herein. In some implementations, one or more of the functions described herein as being performed by the computer system 110 may be performed by the user device 105.

As shown in FIG. 1A, and by reference number 115, the computer system 110 may receive a user input describing a specific scene. For example, the user may provide the user input describing the specific scene to the user device 105, and the user device 105 may provide the user input to the computer system 110. The computer system 110 may receive the user input describing the specific scene from the user device 105. In some implementations, the computer system 110 may present a graphical user interface (GUI) on the user device 105, and the user may utilize the GUI to enter a textual description of the scene they wish to locate within a video file. The GUI may include a dedicated search field or prompt, allowing the user to type a natural language query, such as “show me the moment when the customer installs the router” or “find the scene where the agent demonstrates the troubleshooting steps.” Alternatively, the computer system 110 may support voice-based input, wherein the user provides an audio description of the desired scene. In this case, the user device 105 and/or the computer system 110 may utilize speech recognition technology to transcribe the spoken input into text for further processing.

In some implementations, the user input may include text describing the specific scene, audio describing the specific scene, and/or the like. Additionally, or alternatively, the computer system 110 may accept the user input via the GUI, a command line interface, a speech-to-text module, or another input mechanism. Upon receiving the user input, the computer system 110 may identify the description of the specific scene, and may prepare the user input for contextual analysis, ensuring that the subsequent search process is tailored to the specific details and intent expressed by the user. This may enable the user to initiate highly targeted searches using natural, descriptive language or voice, thereby improving the efficiency and accuracy of locating relevant scenes within lengthy or complex video files.

As further shown in FIG. 1A, and by reference number 120, the computer system 110 may derive and summarize context from the user input to generate a summarized contextual input using a first model. For example, the computer system 110 may be associated with a first model, such as a large language model (e.g., an LLM), a small language model (SLM), a neural network model, an advanced natural language processing model, or another type of artificial intelligence (AI) model capable of semantic understanding of natural language queries. After the computer system 110 receives the user input describing the specific scene, the computer system 110 may utilize the first model to process the user input and generate a summarized contextual input. The first model may parse the user input, and may systematically analyze a sentence structure of the user input, identify main entities, actions, and relationships of the user input, and determine an overall intent behind the user input.

For example, if a user enters a query such as “show me the part where the agent explains the troubleshooting steps,” the first model may extract core elements, such as the subject (“agent”), the action (“explains”), and the context (“troubleshooting steps”). The first model may synthesize the core elements into a concise, standardized summary that captures an essential meaning of the user input. This process may include removing extraneous language, resolving ambiguities, and rephrasing the user input to ensure clarity and consistency. The resulting summarized contextual input may include a distilled representation of the user input, formatted in a way that is compatible with downstream semantic analysis and comparison. In some implementations, the first model may include a Gemini 3 LLM.

By generating this summarized contextual input, the computer system 110 may ensure that subsequent search and matching processes are both efficient and accurate. The summarized contextual input may enable the computer system 110 to compare the user’s intent directly with semantic content of video scenes, facilitating precise retrieval of relevant video segments. In this way, the computer system 110 may bridge the gap between natural, often unstructured user queries and structured data representations required for advanced video search operations.

As shown in FIG. 1B, and by reference number 125, the computer system 110 may assign an input vector to the summarized contextualized input using a paragraph vector model. For example, the computer system 110 may be associated with a paragraph vector model, such as an unsupervised learning model capable of generating a fixed-length feature representation (e.g., a vector) for text segments of varying length. In some implementations, the paragraph vector model may include a Doc2Vec model, a transformer-based embedding model, and/or the like. After the computer system 110 generates the summarized contextual input from the user input, the computer system 110 may utilize the paragraph vector model to transform the summarized contextual input into a numerical representation referred to as an input vector.

To accomplish this, the paragraph vector model may process the summarized contextual input by analyzing a sequence of words, relationships of the sequence of words, and an overall context conveyed in the summarized contextual input. The paragraph vector model may learn to represent the summarized contextual input as a point in a high-dimensional vector space, where semantically similar descriptions are positioned closer together. For example, if the summarized contextual input is “agent explains troubleshooting steps,” the paragraph vector model may encode this phrase into an input vector that reflects an underlying meaning of the phrase. The input vector may distinguish the phrase from unrelated queries, but may be placed near vectors representing similar actions or topics.

The computer system 110 may utilize the input vector to provide efficient and accurate semantic comparison between the user’s intent and content of video scenes. By assigning an input vector to the summarized contextual input, the computer system 110 may create a standardized, machine-readable representation that can be directly compared with vectors derived from video scene summaries. This may enable the computer system 110 to perform advanced similarity searches, matching the user input with relevant segments of video files based on conceptual and contextual alignment rather than simple keyword overlap.

As shown in FIG. 1C, and by reference number 130, the computer system 110 may sample video samples of a video file to be searched. For example, the computer system 110 may receive a video file to be searched before, after, or simultaneously with receipt of the user input. The video file may include a digital recording that contains a sequence of visual images (e.g., accompanied by audio), which can be played back on electronic devices. In some implementations, the video file may be used to capture, store, and share multimedia content such as events, presentations, or interactions. The computer system 110 may sample the video file at fixed intervals (e.g., every two minutes, every N seconds, or a dynamically determined interval) to generate the video samples.

Additionally, or alternatively, the computer system 110 may utilize a reinforcement learning-based model to optimize the sampling rate of the video file based on content density or user requirements. Rather than relying solely on a fixed interval (e.g., every two minutes), the reinforcement learning model may analyze characteristics of the video content (e.g., scene density, detected activity, or historical search performance) to adaptively select sampling intervals that maximize the likelihood of capturing relevant content. This may enable the computer system 110 to allocate greater analytic focus to video segments with higher informational density or contextual significance, while reducing computational overhead for less relevant video segments. The sampling rate may be adjusted in real-time as the video file is processed, providing enhanced flexibility and search accuracy across a diverse range of video file types and use cases. In this way, the computer system 110 may efficiently divide the video file into manageable segments for further analysis.

In some implementations, the computer system 110 may divide lengthy videos, such as a thirty-minute video, into multiple chunks for analysis, ensuring that scene-level context is preserved for each video segment. For example, the computer system 110 may process a thirty-minute video by sequentially segmenting the video into fifteen two-minute chunks, each of which may be analyzed individually. This chunking approach may enable the computer system 110 to maintain a granularity that captures nuanced actions and interactions within each part of the video file. Segmenting the video file before analysis may ensure that the computer system 110 operates on discrete, manageable data units, improving downstream semantic matching. The initial chunking step may prevent lost context in video files with varied scene lengths and density. In some implementations, the chunking approach may support parallel processing, as different video segments can be analyzed simultaneously, increasing throughput of the computer system 110. Furthermore, dividing lengthy video files into chunks may enable the computer system 110 to scale to enterprise-level video libraries without excessive computational load.

As shown in FIG. 1D, and by reference number 135, the computer system 110 may extract and summarize context of the video samples into first sentences using a second model. For example, the computer system 110 may be associated with a second model, such as an LLM, an SLM, a neural network model, an advanced natural language processing model, or another type of AI model. For each video sample (e.g., video segment) of the video file, the computer system 110 may utilize the second model to process visual data, audio data, and any associated metadata of the video sample to identify key entities, actions, context, relationships, and a narrative within a scene. The second model may generate a concise sentence summarizing the scene’s meaning based on the key entities, the actions, the context, the relationships, and the narrative within the scene. In some implementations, the scene analysis may incorporate object detection, activity recognition, or other video analytics methods. By processing multiple video samples, the second model may generate the first sentences, where each first sentence may correspond to a one of the video samples.

The second model may employ advanced natural language processing techniques to interpret the semantic meaning and contextual nuances of the video samples. The second model may systematically review visual and auditory cues in a video sample to discern an underlying intent and significance of a scene in the video sample. Once the relevant contextual information is identified in a video sample, the second model may generate a concise summary sentence that encapsulates a core narrative or action occurring within the video sample. The first sentences of the video samples may serve as distilled representations of scene context, enabling the computer system 110 to efficiently compare, categorize, and retrieve relevant video segments based on user queries (e.g., the user input). In this way, the computer system 110 may provide highly accurate and contextually relevant search results associated with large video files.

As shown in FIG. 1E, and by reference number 140, the computer system 110 may analyze and summarize transcripts of the video samples into second sentences using the first model. For example, the computer system 110 may be associated with the first model, such as an LLM, an SLM, a neural network model, an advanced natural language processing model, or another type of AI model capable of semantic understanding of transcripts. For each video sample, the computer system 110 may obtain a corresponding transcript. A transcript may include a spoken dialogue and other audio-derived textual information from a scene of a video sample. The computer system 110 may provide the transcript as input to the first model, and the first model may process the transcript.

The first model may be designed to process natural language text and may be capable of understanding conversational context, speaker intent, and a flow of dialogue. The first model may examine the transcript (e.g., speech-to-text output) to identify key topics, actions, and interactions that occur within the video sample associated with the transcript. The first model may apply a semantic analysis to extract an essential meaning from the transcript, filtering out irrelevant or repetitive information and focusing on the most significant aspects of the conversation.

Once the relevant content is identified, the first model may generate, based on the relevant content, a concise summary sentence that accurately reflects the core message or event described in the transcript. By processing multiple transcripts, the first model may generate the second sentences, where each second sentence may correspond to a one of the transcripts. The second sentences may distill the transcript information into a format suitable for further processing, such as comparison with user queries (e.g., the user input) or integration into a vector space for semantic search. In this way, the computer system 110 may ensure that the contextual meaning of spoken content within each video sample is efficiently captured and represented for subsequent analysis and retrieval.

In some implementations, the first model and second model may each include an LLM or an SLM that is pre-trained or fine-tuned for the domain of video scene understanding and transcript summarization. For example, the first model may utilize an LLM such as GPT-4, BERT, or a similarly capable transformer-based architecture, configured to accept natural language text or audio-derived text as input and to output a single-sentence summary of the scene context. The second model may likewise employ an LLM or SLM, capable of ingesting video samples and returning a concise summary sentence reflecting the core messages of the video samples. In both cases, the models may achieve a minimum accuracy of 85% on benchmark scene summarization datasets. Input formats may include Unicode Transformation Format (UTF)-8 encoded text, and output formats may be plain text strings or JavaScript Object Notation (JSON) objects containing summary sentences.

In some implementations, the paragraph vector model may be implemented using a Doc2Vec model, a transformer-based embedding model, or a similar unsupervised learning model that generates fixed-length feature representations for input text of arbitrary length. For example, the paragraph vector model may be configured to output a 768-dimensional vector representation for each input sentence, compatible with cosine similarity or Euclidean distance metrics. The paragraph vector model may be trained using a corpus of domain-specific documents, video scene descriptions, and transcript data to ensure robust semantic mapping.

All models may be implemented using standard machine learning frameworks such as TensorFlow, PyTorch, or Hugging Face Transformers, and may be executed locally or in a cloud-based environment as described elsewhere herein. These models may be interoperable by exchanging data using JSON or protocol buffer formats, and may be containerized for deployment within cloud or edge computing environments.

As shown in FIG. 1F, and by reference number 145, the computer system 110 may apply weights based on temporal relevance to the first sentences and the second sentences to generate weighted sentences. For example, after the first model has extracted and summarized the context of each video sample into first sentences, and the second model has analyzed and summarized the transcripts into second sentences, the computer system 110 may associate each sentence with a corresponding timestamp or time interval within the video file. To determine temporal relevance, the computer system 110 may evaluates factor such as a proximity of each sentence’s timestamp to the user input, a duration of a scene, and a frequency or significance of events occurring within the video sample. In some implementations, the computer system 110 may assign higher weights to first or second sentences that are temporally closer to a user- specified time window or to video segments where notable actions, transitions, or conversational cues occur. This weighting process may include algorithmic scoring, where each sentence may be assigned a numerical value reflecting relevance of the sentence within an overall timeline of the video file.

By applying these weights to the first sentences and the second sentences, the computer system 110 may generate weighted sentences that prioritize video segments most likely to contain information pertinent to the user input. The weighted sentences may then be used for vectorization and semantic comparison, and/or to enhance an accuracy and efficiency of scene identification and retrieval. In this way, the computer system 110 may ensure that the most contextually and temporally relevant portions of the video file are surfaced in response to the user input, thereby streamlining the search process and improving downstream matching.

Additionally, or alternatively, the computer system 110 may encode not only a time slot but also a summary and an output from the paragraph vector model for each indexed video segment (e.g., video sample). For example, for an eleven minute video divided into six segments, the computer system 110 may generate six indexed entries, each capturing a time slot, a summary, and a corresponding vector representation. This may enable more precise mapping between temporal locations and semantic meaning, and may facilitate accurate identification of desired time windows. The indexed structure provided by the indexed entries may support efficient retrieval and comparison during a proximity search. Encoding this combined information may enable the computer system 110 to track nuanced changes in context and scene dynamics throughout the video file. In this way, the computer system 110 may provide robust temporal semantic indexing, and may reduce computational overhead during downstream similarity searches.

As shown in FIG. 1G, and by reference number 150, the computer system 110 may translate the weighted sentences into sentence vectors using the paragraph vector model. For example, after the computer system 110 has generated weighted sentences (e.g., each reflecting the contextual and temporal relevance of a scene or transcript segment), the computer system 110 may utilize the paragraph vector model to convert the weighted sentences from textual form into numerical representations within a multidimensional vector space. The paragraph vector model may capture semantic relationships and conceptual similarities between weighted sentences of varying lengths. For each weighted sentence, the paragraph vector model may process the text of the weighted sentence and may generate a fixed-length feature vector that encapsulates a meaning and context of the weighted sentence. This transformation may include mapping linguistic features, such as key entities, actions, and narrative structure, into a high-dimensional space where similar sentences are positioned closer together.

By translating the weighted sentences into sentence vectors, the computer system 110 may enable efficient comparison and retrieval of relevant video segments. The sentence vectors may serve as a basis for subsequent operations, such as identifying closest matches to the user input or clustering of related scenes. The use of the paragraph vector model may ensure that both the nuanced context and the temporal importance of each weighted sentence are preserved in the vector representation, facilitating advanced semantic search capabilities across large video files. In some implementations, the computer system 110 may index the sentence vectors (e.g., via unique identifiers, such as file hashes or database keys) and may store the indexed sentence vectors in a persistent vector database or storage system (e.g., a vector store) for efficient retrieval and comparison with the user input and future user queries. In some implementations, the vector store may be implemented using scalable storage solutions (e.g., cloud-based vector databases) to support large volumes of video data.

In some implementations, the computer system 110 may utilize GraphQL or a similar query protocol to interact with the vector store, enabling rapid and flexible searching, updating, and retrieval of vectors based on various criteria (e.g., video identifier, timestamp, or contextual metadata). This architecture may support scalable search operations and integration with downstream analytics or reporting pipelines, ensuring that both current and future user queries can leverage previously computed semantic representations without redundant processing.

As shown in FIG. 1H, and by reference number 155, the computer system 110 may compare the input vector and the sentence vectors to identify one or more of the sentence vectors that are closest to the input vector. For example, to identify the sentence vectors that are most closely aligned with the input vector, the computer system 110 may utilize a similarity measurement model (e.g., a distance metric) that calculates Euclidean distances, cosine similarities, or other vector similarity measures between vectors. Each sentence vector, corresponding to a weighted sentence from the video samples, may be compared to the input vector to determine a degree of semantic similarity. The computer system may systematically evaluate all sentence vectors and may rank the sentence vectors based on their proximity to the input vector within the vector space.

The sentence vectors that exhibit the smallest distance or highest similarity score to the input vector may be considered the closest matches. The closest matches may indicate that the associated video segments are most relevant to the user input. The computer system 110 may retrieve timestamps (e.g., time slots) and other metadata associated with the closest sentence vectors, enabling precise identification and retrieval of the relevant scenes within the video file. In this way, the computer system 110 may ensure that the user receives highly accurate and contextually appropriate results, streamlining the search and analysis of complex multimedia content.

In some implementations, the computer system 110 may use a configurable threshold to adjust sensitivity of the distance metric, or may return a top number nearest sentence vector neighbors of the input vector. In some implementations, the computer system 110 may utilize a unique identifier of the video file to retrieve the sentence vectors from the vector store, and may map the sentence vectors into the same semantic space as the input vector for direct comparison. For example, upon receiving the user input, the computer system 110 may access the vector store using the video identifier and may fetch all sentence vectors associated with that video identifier, enabling the one-to-one vector distance calculations. The computer system 110 may calculate the Euclidean distance or other similarity metrics between the input vector and each stored sentence vector, and may identify the sentence vectors that fall within a predefined proximity threshold. The predefined proximity threshold may be set to a default value (e.g., six units) but may be adjusted to broaden or narrow the search for more or less similar matches. The computer system 110 may return indexes or timestamps of all sentence vectors satisfying the predefined proximity threshold, supporting comprehensive and flexible search results. In this way, the computer system 110 may ensure that only relevant sentence vectors from the same video file are considered, preventing cross-file contamination.

As shown in FIG. 1I, and by reference number 160, the computer system 110 may output timestamps in the video samples associated with the one or more of the sentence vectors. For example, the computer system 110 may generate an output that include a list of timestamps or time ranges corresponding to the closest matching video samples associated with the one or more sentence vectors. The computer system 110 may provide the output to the user device 105, and the user device 105 may display the output to the user. In some implementations, the computer system 110 may also present metadata, summary sentences, or confidence scores (e.g., associated with the one or more sentence vectors) for user review. In this way, the computer system 110 may direct the user to precise moments within the video file that are contextually and semantically aligned with the user input.

In some implementations, the computer system 110 may output the video samples associated with the one or more of the sentence vectors. For example, after identifying the sentence vectors that are closest to the input vector, the computer system 110 may retrieve and present (e.g., via the user device 105) the actual video samples (e.g., video clips or segments) corresponding to the identified sentence vectors. In some implementations, the computer system 110 may generate and output (e.g., via the user device 105) video thumbnails, preview clips, or links to the relevant video segments, thereby providing immediate visual context to the user. The video samples associated with the one or more of the sentence vectors may be displayed in a user interface that allows the user to select, review, or further analyze the matching video content. Providing the actual video samples along with timestamps and metadata may enable more efficient validation and exploration of the results. In some implementations, the computer system 110 may generate a timestamp link that, when selected, may cause a video player playing a video file to jump to the timestamp associated with the timestamp link.

In this way, the computer system 110 may minimize unnecessary user navigation through irrelevant video content by surfacing only the most contextually relevant video samples.

In some implementations, the computer system 110 may receive a similarity threshold value and adjust identification of the one or more of the sentence vectors that are closest to the input vector based on the similarity threshold value. For example, the user or an administrator of the computer system 110 may specify a threshold that determines a minimum required similarity (e.g., a cosine similarity score) for a sentence vector to be considered a match with the input vector. The computer system 110 may dynamically filter or rank the candidate sentence vectors according to the similarity threshold value before outputting results. The similarity threshold value may be set adaptively based on prior search performance or user feedback to optimize result precision and recall. This capability enables the computer system 110 to tune the sensitivity of matches to user needs, reducing false positives or negatives. In some implementations, adjusting the similarity threshold value can help avoid unnecessary processing of marginally relevant video segments.

As further shown in FIG. 1I, and by reference number 165, the computer system 110 may identify at least one video segment of the video samples based on expanding time windows of each of the timestamps. For example, the computer system 110 may expand each identified timestamp into a larger time window (e.g., by a predetermined margin before and after the timestamp) to include additional contextual content and improve the accuracy of the match. The computer system 110 may identify a video sample (e.g., a video segment) of the video samples (e.g., not previously identified as being associated with the one or more of the sentence vectors) based on the expanded time windows.

In one example, if the computer system 110 identifies a matching timestamp at 12:00, the computer system 110 may extend this timestamp to cover from 8:00 to 16:00, thus capturing more context surrounding a point of interest. In some implementations, the computer system 110 may dynamically determine an optimal window size based on content density or user preferences. The expanded window can then be processed as a whole for raw text extraction and full text matching. This may ensure that subtle but relevant events occurring in a vicinity of a matching sentence vector are not missed during a final analysis. In this way, the computer system 110 may address the challenge of context fragmentation commonly present in traditional video search. In some implementations, the computer system 110 may utilize a dynamic window expansion strategy that iteratively increases a context window as long as a relevance score improves and that terminates the expansion once the marginal context gain diminishes. A minimum window size may be set to two minutes and a maximum window size may be set to ten minutes.

In some implementations, the computer system 110 may identify and retrieve multiple instances of a scene or event within a video file, allowing the user to locate all relevant occurrences efficiently. For example, if a user searches for a scene where a plane door opens, the computer system 110 may return timestamps at one-hundred and sixty-two (162) seconds and one-hundred and eighty-six (186) seconds, corresponding to two different instances of that action in the video file. The computer system 110 may analyze the video file and the transcript data to detect repeated actions, ensuring that each instance is indexed and accessible. In some implementations, the user may review all matching video segments and may select the video segments of greatest interest, without missing repeated scenes. Supporting multi-instance retrieval may be particularly important in video files with recurring actions or events.

As further shown in FIG. 1I, and by reference number 170, the computer system 110 may output the at least one video segment as being most relevant to the user input. For example, the computer system 110 may analyze the content of the video segments associated with the one or more of the matching sentence vectors to ensure that key entities, actions, or conversational cues specified in the user input are included in the video segments. In some implementations, the computer system 110 may expand time windows around the matched video segment and may perform a full-text match to identify the at least one video segment as being most relevant to the user input (e.g., includes the most pertinent information). The computer system 110 may provide the at least one video segment to the user device 105, and the user device 105 may display the at least one video segment to the user. By integrating semantic, contextual, and temporal analysis, the computer system 110 may confidently determine which video segment or video segments are most relevant to the user input.

In some implementations, the computer system 110 may enable direct comparison between the user input and the extracted video actions or transcript details, supporting nuanced searches such as validation of specific steps or error scenarios. For example, the user may input a query asking whether a customer support agent performed a particular troubleshooting step, and the computer system 110 may analyze the video file to identify and validate the presence of the troubleshooting step. In some implementations, the computer system 110 may compare extracted raw text against the user input to confirm action execution or detect user sentiment. This approach may enable the computer system 110 to handle searches for subtle behavioral patterns, such as hesitation or error occurrence, by leveraging both visual and transcript-based summaries. In some implementations, the user may input queries for specialized scenarios, such as checking for promotional displays or inappropriate content, and the computer system 110 may return only the relevant matching video segments. By combining semantic vector comparison and full text matching may enable the computer system 110 to support highly targeted, resource-efficient validation of complex queries.

As shown in FIG. 1J, and by reference number 175, the computer system 110 may convert the at least one video segment into raw text. For example, once the computer system 110 has identified the at least one video segment based on semantic and contextual analysis, the computer system 110 may extract audio data associated with the at least one video segment. The computer system 110 may process the audio data using a speech-to-text engine, which may be integrated with or powered by an LLM capable of recognizing and transcribing spoken language with high accuracy.

During transcription, the computer system 110 may analyze the audio for spoken words, speaker identification, and conversational cues, and may convert the entire content of the at least one video segment into a textual representation. This process may also include the detection of non-verbal sounds, pauses, and emphasis, which can be annotated or included in the raw text to preserve the full context of the at least one video segment. The resulting raw text may provide a verbatim record of all dialogue and audible information present in the at least one video segment, without any summarization or filtering.

By converting the at least one video segment into raw text, the computer system 110 may enable advanced text-based analysis, such as full-text search, sentiment analysis, and keyword extraction. The raw textual data may then be used for further processing, including matching against user queries, generating reports, or supporting compliance and review workflows. The conversion to raw text may ensure that all relevant information within the at least one video segment is accessible for downstream analysis and decision-making processes.

As further shown in FIG. 1J, and by reference number 180, the computer system 110 may perform a full text match on the raw text to generate a result for the user input. For example, after the computer system 110 has converted the at least one video segment into the raw text, the computer system 110 may scan the entire raw text of the at least one video segment to identify exact or closely related matches to the user input. The computer system 110 may utilize techniques such as keyword matching, phrase detection, and semantic similarity analysis to ensure that variations in language or phrasing are accounted for. If the user input is found within the raw text, the computer system 110 may mark the location and context of the match, such as the specific sentence or time within the at least one video segment. Once a match is identified, the computer system 110 may generate a result that highlights the relevant portion of the raw text and provides metadata such as the corresponding timestamp, speaker information, or surrounding dialogue.

As further shown in FIG. 1J, and by reference number 185, the computer system 110 may output the result. For example, the computer system 110 may present the result to the user (e.g., via the user device 105) in a format that allows for direct review of the matched content, facilitating efficient verification and analysis. By performing a full text match, the computer system 110 may ensure that the user receives the most precise and contextually accurate response to the user input, further enhancing the effectiveness of scene-level video search and retrieval.

The implementations described herein may be applied across a variety of use cases. For example, in customer support environments, the computer system 110 can automatically tag support tickets with relevant keywords derived from analyzed customer interactions, streamlining case routing and post-call analysis. In addition, the computer system 110 may be used to monitor large volumes of multimedia content, such as news broadcasts, social media videos, and user-generated livestreams, to identify and flag inappropriate, harmful, or brand-related content. By surfacing critical moments (e.g., error messages, rage clicks, or abandoned carts), the computer system 110 may accelerate troubleshooting and root cause analysis. Furthermore, teams may employ the computer system 110 to search for emotional cues, patterns of hesitation, or sentiment within scene-level video segments, leading to a deeper understanding of customer pain points and needs.

In this way, a device (e.g., the computer system 110 and/or the user device 105) searches video content using contextual input. For example, the device may overcome the inefficiencies of manual review and basic transcript-based search by utilizing contextual understanding and semantic comparison at a scene level. The device may reduce computational overhead by narrowing the search space to only segments that are contextually and semantically relevant. Additionally, by encoding and indexing video samples as vectors, the device may enable efficient retrieval and comparison operations, which may reduce latency and network resource consumption. The device may provide scalable video analytics and may integrate with automated downstream analysis pipelines, such as compliance monitoring or sentiment detection, without incurring the resource penalties associated with exhaustive or less targeted search methods. Thus, the device may conserve computing resources, networking resources, and/or other resources that would have otherwise been consumed by being limited to basic metadata or transcript-based keyword searching of video files, failing to capture nuanced context or meaning within individual scenes of video files, requiring manual review of entire videos to locate relevant segments based on failing to capture context or meaning within scenes of video files, and/or the like, and/or the like.

As indicated above, FIGS. 1A-1J are provided as an example. Other examples may differ from what is described with regard to FIGS. 1A-1J. The number and arrangement of devices shown in FIGS. 1A-1J are provided as an example. In practice, there may be additional devices, fewer devices, different devices, or differently arranged devices than those shown in FIGS. 1A-1J. Furthermore, two or more devices shown in FIGS. 1A-1J may be implemented within a single device, or a single device shown in FIGS. 1A-1J may be implemented as multiple, distributed devices. Additionally, or alternatively, a set of devices (e.g., one or more devices) shown in FIGS. 1A-1J may perform one or more functions described as being performed by another set of devices shown in FIGS. 1A-1J.

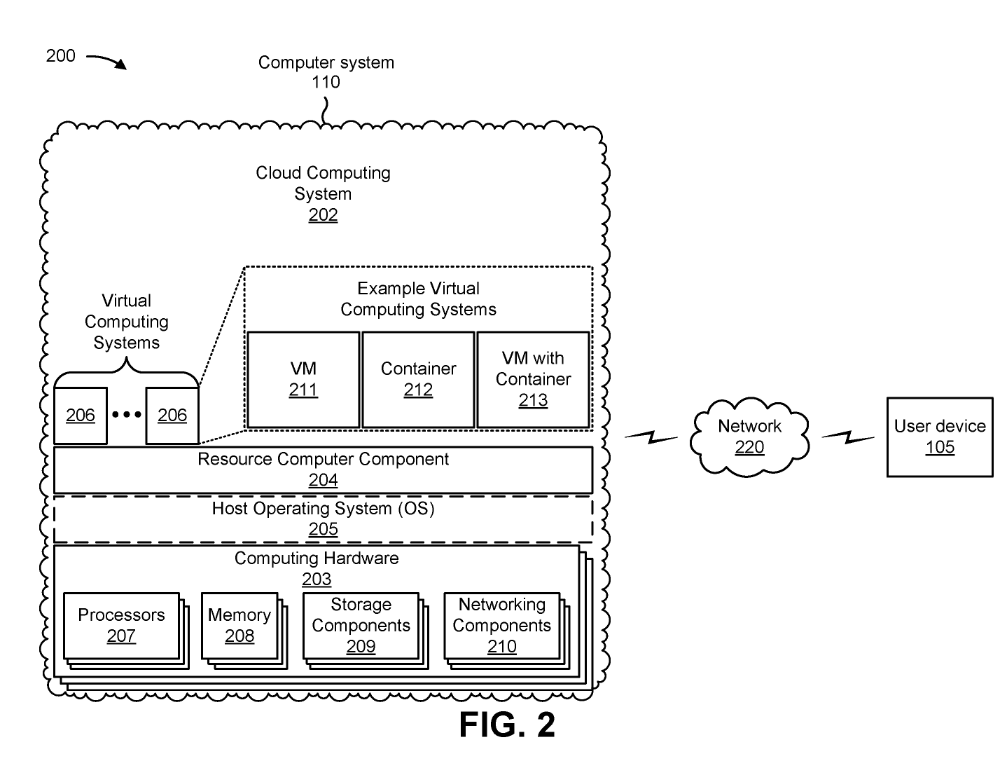

FIG. 2 is a diagram of an example environment 200 in which systems and/or methods described herein may be implemented. As shown in FIG. 2, the environment 200 may include the computer system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a virtual assistant device, or a similar type of device. In some implementations, the user device 105 may include a camera that captures images, audio, and/or videos (e.g., images and audio). The camera may feed real-time images and/or video directly to the user device 105 or the display of the user device 105, may record captured images and/or video to a storage device for archiving or further processing, and/or the like.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

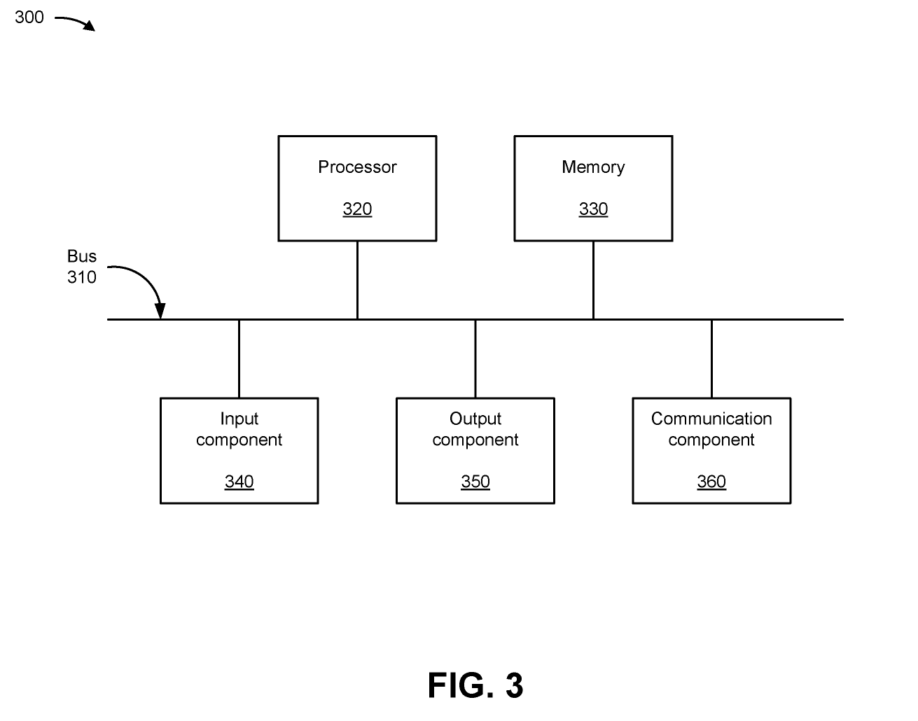

Although the computer system 110 may include one or more elements 203-213 of the cloud computing system 202, may execute within the cloud computing system 202, and/or may be hosted within the cloud computing system 202, in some implementations, the computer system 110 may not be cloud-based (e.g., may be implemented outside of a cloud computing system) or may be partially cloud-based. For example, the computer system 110 may include one or more devices that are not part of the cloud computing system 202, such as the device 300 of FIG. 3, which may include a standalone server or another type of computing device. The computer system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the computer system 110. In some implementations, the user device 105 and/or the computer system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

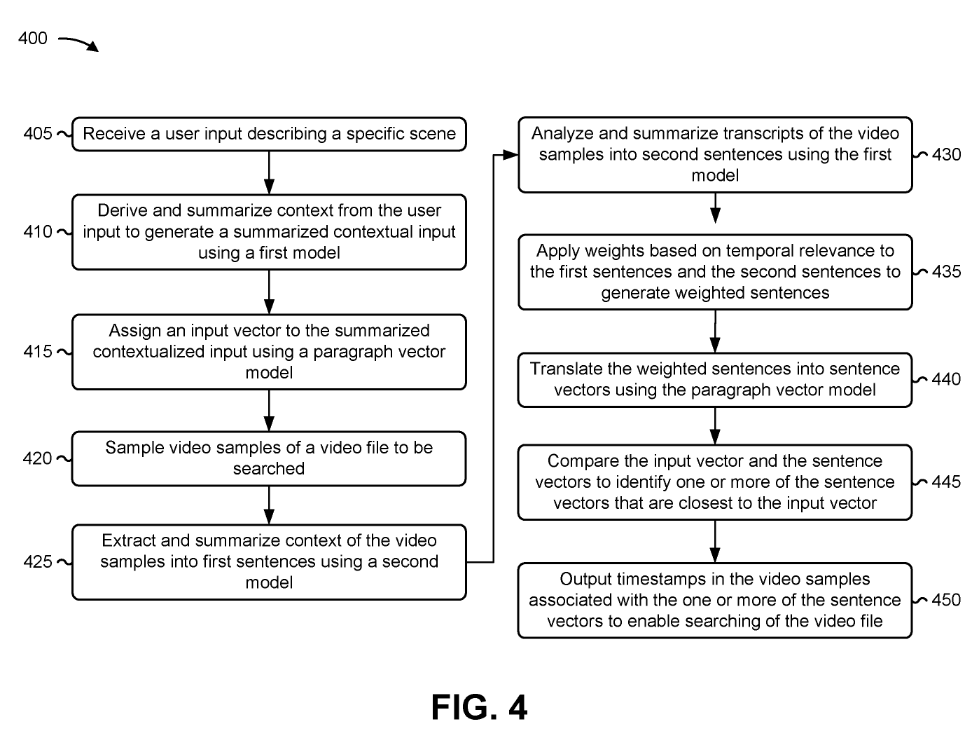

FIG. 4 is a flowchart of an example process 400 for searching video content using contextual input. In some implementations, one or more process blocks of FIG. 4 may be performed by a device (e.g., the computer system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a user input describing a specific scene (block 405). For example, the device may receive a user input describing a specific scene, as described above. In some implementations, the user input includes one of text describing the specific scene or audio describing the specific scene.

As further shown in FIG. 4, process 400 may include deriving and summarizing context from the user input to generate a summarized contextual input using a first model (block 410). For example, the device may derive and summarize context from the user input to generate a summarized contextual input using a first model, as described above.

As further shown in FIG. 4, process 400 may include assigning an input vector to the summarized contextualized input using a paragraph vector model (block 415). For example, the device may assign an input vector to the summarized contextualized input using a paragraph vector model, as described above. In some implementations, the paragraph vector model is an unsupervised learning model that generates a fixed-length feature representation for varying lengths of text.

As further shown in FIG. 4, process 400 may include sampling video samples of a video file to be searched (block 420). For example, the device may sample video samples of a video file to be searched, as described above.

As further shown in FIG. 4, process 400 may include extracting and summarizing context of the video samples into first sentences using a second model (block 425). For example, the device may extract and summarize context of the video samples into first sentences using a second model, as described above.

As further shown in FIG. 4, process 400 may include analyzing and summarizing transcripts of the video samples into second sentences using the first model (block 430). For example, the device may analyze and summarize transcripts of the video samples into second sentences using the first model, as described above.

As further shown in FIG. 4, process 400 may include applying weights based on temporal relevance to the first sentences and the second sentences to generate weighted sentences (block 435). For example, the device may apply weights based on temporal relevance to the first sentences and the second sentences to generate weighted sentences, as described above.

As further shown in FIG. 4, process 400 may include translating the weighted sentences into sentence vectors using the paragraph vector model (block 440). For example, the device may translate the weighted sentences into sentence vectors using the paragraph vector model, as described above.

As further shown in FIG. 4, process 400 may include comparing the input vector and the sentence vectors to identify one or more of the sentence vectors that are closest to the input vector (block 445). For example, the device may compare the input vector and the sentence vectors to identify one or more of the sentence vectors that are closest to the input vector, as described above.

As further shown in FIG. 4, process 400 may include outputting timestamps in the video samples associated with the one or more of the sentence vectors to enable searching of the video file (block 450). For example, the device may output timestamps in the video samples associated with the one or more of the sentence vectors to enable searching of the video file, as described above.

In some implementations, process 400 includes expanding time windows of each of the timestamps, identifying at least one video segment of the video samples based on expanding the time windows of each of the timestamps, and marking a timestamp of the at least one video segment in the video file. In some implementations, process 400 includes outputting the at least one video segment as being most relevant to the user input. In some implementations, process 400 includes converting the at least one video segment into raw text, performing a full text match on the raw text to generate a result for the user input, and outputting the result.

In some implementations, process 400 includes outputting the video samples associated with the one or more of the sentence vectors. In some implementations, process 400 includes storing the sentence vectors and associated timestamps in a vector store indexed by a unique identifier for the video file. In some implementations, process 400 includes outputting the video samples associated with the one or more of the sentence vectors. In some implementations, process 400 includes sampling the video file at fixed intervals to generate the video samples.

In some implementations, process 400 includes utilizing a distance metric between the input vector and the sentence vectors to identify the one or more of the sentence vectors that are closest to the input vector. In some implementations, process 400 includes storing the sentence vectors and associated timestamps in a vector store indexed by a unique identifier for the video file. In some implementations, process 400 includes receiving a similarity threshold value, and adjusting identification of the one or more of the sentence vectors that are closest to the input vector based on the similarity threshold value.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a user input describing a specific scene;
deriving and summarizing, by the device, context from the user input to generate a summarized contextual input using a first model;
assigning, by the device, an input vector to the summarized contextualized input using a paragraph vector model;
sampling, by the device, video samples of a video file to be searched;
extracting and summarizing, by the device, context of the video samples into first sentences using a second model;
analyzing and summarizing, by the device, transcripts of the video samples into second sentences using the first model;
applying, by the device, weights based on temporal relevance to the first sentences and the second sentences to generate weighted sentences;
translating, by the device, the weighted sentences into sentence vectors using the paragraph vector model;
comparing, by the device, the input vector and the sentence vectors to identify one or more of the sentence vectors that are closest to the input vector; and
outputting, by the device, timestamps in the video samples associated with the one or more of the sentence vectors to enable searching of the video file.

2. The method of claim 1, further comprising:
expanding time windows of each of the timestamps;
identifying at least one video segment of the video samples based on expanding the time windows of each of the timestamps; and
marking a timestamp of the at least one video segment in the video file.

3. The method of claim 2, further comprising:
outputting the at least one video segment as being most relevant to the user input.

4. The method of claim 2, further comprising:
converting the at least one video segment into raw text;
performing a full text match on the raw text to generate a result for the user input; and
outputting the result.

5. The method of claim 1, wherein the user input includes one of text describing the specific scene or audio describing the specific scene.

6. The method of claim 1, further comprising:
outputting the video samples associated with the one or more of the sentence vectors.

7. The method of claim 1, further comprising:
storing the sentence vectors and associated timestamps in a vector store indexed by a unique identifier for the video file.

8. A device, comprising:
one or more processors configured to:
receive a user input describing a specific scene, wherein the user input includes one of text describing the specific scene or audio describing the specific scene;
derive and summarize context from the user input to generate a summarized contextual input using a first model;
assign an input vector to the summarized contextualized input using a paragraph vector model;
sample video samples of a video file to be searched;
extract and summarize context of the video samples into first sentences using a second model;
analyze and summarize transcripts of the video samples into second sentences using the first model;
apply weights based on temporal relevance to the first sentences and the second sentences to generate weighted sentences;
translate the weighted sentences into sentence vectors using the paragraph vector model;
compare the input vector and the sentence vectors to identify one or more of the sentence vectors that are closest to the input vector; and
output timestamps in the video samples associated with the one or more of the sentence vectors to enable searching of the video file.

9. The device of claim 8, wherein the one or more processors are further configured to:
output the video samples associated with the one or more of the sentence vectors.

10. The device of claim 8, wherein the one or more processors, to sample the video samples of the video file to be searched, are configured to:
sample the video file at fixed intervals to generate the video samples.

11. The device of claim 8, wherein the one or more processors, to compare the input vector and the sentence vectors to identify the one or more of the sentence vectors that are closest to the input vector, are configured to:
utilize a distance metric between the input vector and the sentence vectors to identify the one or more of the sentence vectors that are closest to the input vector.

12. The device of claim 8, wherein the paragraph vector model is an unsupervised learning model that generates a fixed-length feature representation for varying lengths of text.

13. The device of claim 8, wherein the one or more processors are further configured to:
store the sentence vectors and associated timestamps in a vector store indexed by a unique identifier for the video file.

14. The device of claim 8, wherein the one or more processors are further configured to:
receive a similarity threshold value; and
adjust identification of the one or more of the sentence vectors that are closest to the input vector based on the similarity threshold value.

15. A non-transitory computer-readable medium storing a set of instructions, the set of instructions comprising:
one or more instructions that, when executed by one or more processors of a device, cause the device to:
receive a user input describing a specific scene, wherein the user input includes one of text describing the specific scene or audio describing the specific scene;
derive and summarize context from the user input to generate a summarized contextual input using a first model;
assign an input vector to the summarized contextualized input using a paragraph vector model;
sample video samples of a video file to be searched;
extract and summarize context of the video samples into first sentences using a second model;
analyze and summarize transcripts of the video samples into second sentences using the first model;
apply weights based on temporal relevance to the first sentences and the second sentences to generate weighted sentences;
translate the weighted sentences into sentence vectors using the paragraph vector model;
compare the input vector and the sentence vectors to identify one or more of the sentence vectors that are closest to the input vector;
generate timestamps in the video samples associated with the one or more of the sentence vectors;
expand time windows of each of the timestamps;
identify at least one video segment of the video samples based on expanding the time windows of each of the timestamps; and
mark a timestamp of the at least one video segment in the video file.

16. The non-transitory computer-readable medium of claim 15, wherein the one or more instructions further cause the device to:
output the at least one video segment as being most relevant to the user input.

17. The non-transitory computer-readable medium of claim 15, wherein the one or more instructions further cause the device to:
convert the at least one video segment into raw text;
perform a full text match on the raw text to generate a result for the user input; and
output the result.

18. The non-transitory computer-readable medium of claim 15, wherein the one or more instructions, that cause the device to sample the video samples of the video file to be searched, cause the device to:
sample the video file at fixed intervals to generate the video samples.

19. The non-transitory computer-readable medium of claim 15, wherein the one or more instructions, that cause the device to compare the input vector and the sentence vectors to identify the one or more of the sentence vectors that are closest to the input vector, cause the device to:
utilize a distance metric between the input vector and the sentence vectors to identify the one or more of the sentence vectors that are closest to the input vector.

20. The non-transitory computer-readable medium of claim 15, wherein the one or more instructions further cause the device to:
store the sentence vectors and associated timestamps in a vector store indexed by a unique identifier for the video file.
